(19) United States
(12) Patent Application Publication
(10) Pub. No.: US 2022/0232613 A1
(43) Pub. Date: Jul. 21, 2022

(54) RELIABLE DATA TRANSMISSION OVER MULTIPLE TRPs

(71) Applicant: Telefonaktiebolaget LM Ericsson (publ), Stockholm (SE)

(72) Inventors: Shiwei Gao, Nepean (CA); Sebastian Faxér, Stockholm (SE); Mattias Frenne, Uppsala (SE); Siva Muruganathan, Stittsville (CA)

(21) Appl. No.: 17/608,544

(22) PCT Filed: Apr. 30, 2020
(86) PCT No.: PCT/IB2020/054123

§ 371 Date: Nov. 3, 2021

Related U.S. Application Data
(60) Provisional application No. 62/843,071, filed on May 3, 2019.

(51) Int. Cl. H04W 72/12; H04L 1/18; H04L 5/00

(52) U.S. Cl. CPC H04W 72/1289; H04L 5/0035; H04L 1/1812

(57) ABSTRACT

Systems and methods for reliable data transmission over multiple Transmission Reception Points (TRPs) are provided. In some embodiments, a method performed by a wireless device includes: receiving first control data on a first control channel from a first TRP; receiving and processing first data from the first TRP based on the first control data; receiving second control data on a second control channel from a second TRP; and receiving and processing second data from the second TRP based on the second control data, wherein the first data and the second data are associated to a same data Transport Block (TB). In this way, link adaptation can be performed according to the channel condition of each TRP and thus better utilization of each TRP link for improved data reliability and system capacity are provided.

### RELATED APPLICATIONS

This application claims the benefit of provisional patent application Ser. No. 62/843,071, filed May 3, 2019, the disclosure of which is hereby incorporated herein by reference in its entirety.

### TECHNICAL FIELD

The current disclosure relates to reliable data transmission.

### BACKGROUND

The new fifth generation mobile wireless communication system (5G) or New Radio (NR) supports a diverse set of use cases and a diverse set of deployment scenarios. NR uses Cyclic Prefix Orthogonal Frequency Division Multiplexing (CP-OFDM) in the downlink (i.e., from a network node, New Radio Base Station (gNB), evolved or enhanced Node B (eNB), or base station, to a user equipment (UE)) and both CP-OFDM and Discrete Fourier Transform-spread OFDM (DFT-S-OFDM) in the uplink (i.e., from UE to gNB). In the time domain, NR downlink and uplink physical resources are organized into equally-sized subframes of 1 ms each. A subframe is further divided into multiple slots of equal duration.

The slot length depends on subcarrier spacing. For subcarrier spacing of Δf=15 kHz, there is only one slot per subframe, and each slot always consists of 14 OFDM symbols, irrespectively of the subcarrier spacing.

Typical data scheduling in NR is performed on a per slot basis; an example is shown in FIG. 1 where the first two symbols contain Physical Downlink Control Channel (PDCCH) and the remaining 12 symbols contains Physical Data Channel (PDCH), either a Physical Downlink Shared Channel (PDSCH) or Physical Uplink Data Channel (PUSCH).

Different subcarrier spacing values are supported in NR. The supported Subcarrier Spacing (SCS) values (also referred to as different numerologies) are given by Δf=(15×2^{α}) kHz where α∈(0, 1, 2, 4, 8). Δf=15 kHz is the basic subcarrier spacing that is also used in LTE, the corresponding slot duration is 1 ms. For a given SCS, the corresponding slot duration is

$$\frac{1}{{2}^{α}}$$

ms.

In the frequency domain physical resource definition, a system bandwidth is divided into Resource Blocks (RBs), each corresponds to 12 contiguous subcarriers. The basic NR physical time-frequency resource grid is illustrated in FIG. 2, where only one Resource Block (RB) within a 14-symbol slot is shown. One OFDM subcarrier during one OFDM symbol interval forms one Resource Element (RE).

Downlink transmissions can be dynamically scheduled, i.e., in each slot the gNB transmits Downlink Control Information (DCI) over the PDCCH about which UE data is to be transmitted to and which RBs and OFDM symbols in the current downlink slot the data is transmitted on. The PDCCH is typically transmitted in the first one or two OFDM symbols in each slot in NR. The UE data are carried on PDSCH. A UE first detects and decodes the PDCCH and if the decoding is successful, it then decodes the corresponding PDSCH based on the decoded control information in the PDCCH.

Uplink data transmission can also be dynamically scheduled using the PDCCH. Similar to downlink, a UE first decodes uplink grants in the PDCCH and then transmits data over the PUSCH based on the decoded control information in the uplink grant such as modulation order, coding rate, uplink resource allocation, etc.

Channel State Information (CSI) feedback is used by the gNB to obtain Downlink (DL) CSI from a UE in order to determine how to transmit DL data to a UE over a plurality of antenna ports. CSI typically includes a channel Rank Indicator (RI), a Precoding Matrix Indicator (PMI) and a Channel Quality Indicator (CQI). RI is used to indicate the number of spatial layers (or transmission layers) that can be transmitted simultaneously to a UE, PMI is used to indicate the precoding matrix over the indicated data layers, and CQI is used to indicate the Modulation and Coding Scheme (MCS) that can be achieved with the indicated rank and the precoding matrix. The number of spatial layers and MCS for a dynamically scheduled PDSCH transmission in a slot is indicated to a UE in the corresponding PDCCH. This allows the transmission to be adapted to the channel conditions.

NR Hybrid Automatic Repeat Request (HARQ) and HARQ Acknowledgement/Negative Acknowledgement (ACK/NACK, sometimes referred to herein as A/N) feedback. Up to 16 HARQ processes can be configured in NR. Each PDSCH is assigned with a HARQ process number or identity, which is indicated in the corresponding PDCCH. When receiving a PDSCH in the downlink from a serving gNB at slot n, a UE feeds back a HARQ ACK at slot n+k over a Physical Uplink Control Channel (PUCCH) resource in the uplink to the gNB if the PDSCH is decoded successfully, otherwise, the UE sends a HARQ NACK at slot n+k to the gNB to indicate that the PDSCH is not decoded successfully, where k is typically indicated in the corresponding PDCCH scheduling the PDSCH.

For DCI format 1-0, k is indicated by a 3-bit PDSCH-to-HARQ-timing-indicator field. For DCI format 1-1, k is indicated either by a 3-bit PDSCH-to-HARQ-timing-indicator field, if present, or by higher layer parameter dl-DataToUL-ACK through Radio Resource Control (RRC) signaling.

In case of Carrier Aggregation (CA) with multiple carriers and/or TDD operation, multiple aggregated HARQ ACK/NACK bits need to be sent in a single PUCCH.

A UE can be configured with up to four PUCCH resource sets. It determines the PUCCH resource set in a slot based on the number of aggregated Uplink Control Information (UCI) bits to be sent in the slot. The UCI bits consist of HARQ ACK/NACK, Scheduling Request (SR), and CSI bits.

For a PUCCH transmission with HARQ-ACK information, a UE determines a PUCCH resource after determining a PUCCH resource set. The PUCCH resource determination is based on a 3-bit PUCCH Resource Indicator (PRI) field in DCI format 1_0 or DCI format 1_1.

If more than one DCI format 1_0 or 1_1 are received in the case of CA and/or TDD, the PUCCH resource determination is based on a PRI field in the last DCI format 1_0 or DCI format 1_1 among the multiple received DCI format 1_0 or DCI format 1_1 indicating a same slot for the PUCCH transmission. The detected DCI formats are first indexed in an ascending order across serving cell indexes for a same PDCCH monitoring occasion and are then indexed in an ascending order across PDCCH monitoring occasion indexes.

There is a restriction in NR on how often a PDSCH belonging to the same HARQ process can be transmitted. According the NR specification, the UE is not expected to receive another PDSCH for a given HARQ process until after the end of the expected transmission of HARQ-ACK for that HARQ process.

When a HARQ NACK is received by a gNB for a PDSCH, the gNB may send another PDSCH carrying the same data Transport Block (TB) to the UE. For each HARQ process, the UE keeps a so-called soft buffer to store the soft bits of PDSCH with decoding errors. When a retransmitted PDSCH is received, the UE combines the soft bits of the current PDSCH with the soft bits already in the soft buffer to achieve better decoding performance. When a PDSCH is decoded successfully, the corresponding soft buffer is cleared. The UE recognizes a PDSCH retransmission through a New Data Indication (NDI) field in the DCI scheduling the PDSCH. If the bit is toggled from a last received NDI bit, it indicates a new PDSCH transmission with a new TB. Otherwise, it indicates a PDSCH retransmission of the same TB. A PDSCH retransmission typically sends a different part of encoded bits in a circular buffer for a TB to maximize decoding performance through soft combining. The different parts are referred to as different Redundancy Versions (RVs). Four RVs, (0, 1, 2, 3), are defined in LTE and NR.

Slot Aggregation: To improve cell coverage range, slot aggregation is supported in NR in which multiple PDSCHs carrying a same TB, but with different RVs, may be transmitted in several consecutive slots triggered by a single PDCCH if the UE is configured with a higher layer parameter pdsch-AggregationFactor. The same resource and MCS allocations are applied across the pdsch-AggregationFactorconsecutive slots. The PDSCH is limited to a single transmission layer. The redundancy version to be applied on the n^{th} transmission occasion of the TB is determined according to the table below, where rv_{id} is the RV identity number.

Table 1 shows the applied redundancy version when pdsch-AggregationFactor is present, where rv_{id} is the RV identity number.

TABLE 1

| rv_{id} indicated | | | | |
|---|---|---|---|---|
| by the DCI | rv_{id} to be applied to n^{th} transmission | | | |
| scheduling the | occasion | | | |
| PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

For slot aggregation with N_{PDSCH}^{repeat} consecutive slots, the UE reports HARQ-ACK information for a PDSCH reception from slot n−N_{PDSCH}^{repeat}+1 to slot n only in a HARQ-ACK codebook that the UE includes in a PUCCH or PUSCH transmission in slot n+k, where k is a number of slots indicated by the PDSCH-to-HARQ_feedback timing indicator field in a corresponding DCI format or provided by the higher layer parameter, dl-DataToUL-ACK, if the PDSCH-to-HARQ feedback timing field is not present in the DCI format.

QCL and TCI states: Several signals can be transmitted from different antenna ports of the same base station antenna. These signals can have the same large-scale properties, for instance in terms of Doppler shift/spread, average delay spread, or average delay. These antenna ports are then said to be Quasi Co-Located (QCL).

The network can then signal to the UE that two antenna ports are QCL. If the UE knows that two antenna ports are QCL with respect to a certain parameter (e.g., Doppler spread), the UE can estimate that parameter based on one of the antenna ports and use that estimate when receiving the other antenna port. Typically, the first antenna port is represented by a measurement reference signal such as a Channel State Information Reference Signal (CSI-RS) (known as source Reference Signal (RS)) and the second antenna port is a Demodulation Reference Signal (DMRS) (known as target RS).

For instance, if antenna ports A and B are QCL with respect to average delay, the UE can estimate the average delay from the signal received from antenna port A (known as the source Reference Signal (RS)) and assume that the signal received from antenna port B (target RS) has the same average delay. This is useful for demodulation since the UE can know beforehand the properties of the channel when trying to measure the channel utilizing the DMRS.

The network signals to the UE information about what assumptions can be made regarding QCL. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. Note that for beam management, the discussion mostly revolves around QCL Type D, but it is also necessary to convey a Type A QCL relation for the RSs to the UE so that it can estimate all the relevant large-scale parameters.

Typically, this is achieved by configuring the UE with a CSI-RS for tracking (TRS) for time/frequency offset estimation. To be able to use any QCL reference, the

UE would have to receive it with a sufficiently good Signal to Interference Plus Noise Ratio (SINR). In many cases, this means that the TRS must be transmitted in a suitable beam to a certain UE.

To introduce dynamics in beam and Transmission Reception Point (TRP) selection, the UE can be configured through RRC signaling with N Transmission Configuration Indicator (TCI) states, where N is up to 128 in Frequency Range 2 (FR2) and up to eight in FR1, depending on UE capability.

Each TCI state contains QCL information, i.e., one or two source DL RSs, each source RS associated with a QCL type. For example, a TCI state contains a pair of reference signals, each associated with a QCL type, e-g-two different CSI-RSs {CSI-RS1, CSI-R52} is configured in the TCI state as {qcl-Type1, qcl-Type2}={Type A, Type D}. It means the UE can derive Doppler shift, Doppler spread, average delay, delay spread from CSI-RS1 and Spatial Rx parameter (i.e., the RX beam to use) from CSI-RS2. In case type D (spatial information) is not applicable, such as low or mid-band operation, then a TCI state contains only a single source RS.

Each of the N states in the list of TCI states can be interpreted as a list of N possible beams transmitted from the network or a list of N possible TRPs used by the network to communicate with the UE.

A first list of available TCI states is configured for PDSCH, and a second list for PDCCH contains pointers, known as TCI State IDs, to a subset of the TCI states configured for PDSCH. The network then activates one TCI state per control resource set (CORESET) for PDCCH (i.e., provides a TCI for PDCCH) and up to M active TCI states for PDSCH. TCI state for a PDCCH is the TCI state activated for a CORESET over which the PDCCH is transmitted. The number M of active TCI states the UE can support is a UE capability but the maximum in NR Rel-15 is eight.

Each configured TCI state contains parameters for the QCL associations between source reference signals (CSI-RS or Synchronization Signal (SS)/Physical Broadcasting Channel (PBCH)) and target reference signals (e.g., PDSCH/PDCCH DMRS ports). TCI states are also used to convey QCL information for the reception of CSI-RS.

Assume a UE is activated with 4 active TCI states (from a list of totally 64 configured TCI states). Hence, 60 TCI states are inactive, and the UE need not be prepared to have large scale parameters estimated for those. But the UE continuously tracks and updates the large-scale parameters for the 4 active TCI states by measurements and analysis of the source RSs indicated by each TCI state.

In NR Rel-15, when scheduling a PDSCH to a UE, the DCI contains a pointer to one active TCI. The UE then knows which large-scale parameter estimate to use when performing PDSCH DMRS channel estimation and thus PDSCH demodulation.

In NR Rel-16, there are discussions ongoing on the support of PDSCH with multiple transmission points (TRP). One mechanism that is being considered in NR Rel-16 is a single PDCCH scheduling one or multiple PDSCHs from different TRPs. The single PDCCH is received from one of the TRPs. FIG. 3 shows an example where a DCI received by the UE in PDCCH from TRP1 schedules two PDSCHs. The first PDSCH

(PDSCH1) is received from TRP1, and the second PDSCH (PDSCH2) is received from TRP2. Alternatively, the single PDCCH schedules a single PDSCH where PDSCH layers are grouped into two groups and where layer group 1 is received from TRP1 and layer group 2 is received from TRP2. In such cases, each PDSCH or layer group is transmitted from a different TRP has a different TCI state associated with it. In the example of FIG. 3, PDSCH1 is associated with TCI State p, and PDSCH 2 is associated with TCI state q.

Reliable data transmission with multiple panels or Transmission Reception Points (TRPs) has been proposed in 3GPP for Rel-16, in which a data packet may be transmitted over multiple TRPs to achieve diversity. An example is shown FIG. 4, where the two PDSCHs carry the same TB but with the same or different redundancy versions so that the UE can do soft combining of the two PDSCHs to achieve more reliable reception.

In 3GPP RAN1 #96bis, it was agreed that a slot based Time Domain Multiplexing (TDM) scheme (scheme 4), similar to slot aggregation in NR R15, will be supported in NR Rel-16, in which PDSCHs in consecutive slots may be transmitted from different TRPs. The transmissions from different TRPs correspond to different TCI states (i.e., a different TCI state is associated with the PDSCH transmitted from each different TRP). An example is shown in FIG. 5, where four PDCHs for a same TB are transmitted over four TRPs and four consecutive slots. Each PDSCH is associated with a different RV. The RV and TRP associated with each slot can be either preconfigured or dynamically signaled.

There currently exist certain challenges. With the 3GPP agreed TDM scheme for PDSCH transmission, only a common MCS and rank can be used for the multiple PDSCHs. For single TRP transmission, a common MCS and rank is fine as the channel will not change much over a few consecutive slots. For multi-TRP, however, the channels between different TRPs and a UE can be very different. Using a single common MCS and rank would be difficult to adapt the channel conditions in different

TRPs and thus is not efficient in fully utilizing the channel capacities for reliable data transmission. In addition, since PDCCH is still transmitted from a single TRP, the PDCCH reliability is not enhanced. As such, improved systems and methods are needed.

### SUMMARY

Systems and methods for reliable data transmission over multiple Transmission Reception Points (TRPs) are provided. In some embodiments, a method performed by a wireless device for reliable data transmission in a wireless network including multiple transmission points includes: receiving first control data on a first control channel from a first one of the plurality of transmission points; receiving and processing first data from the first one of the plurality of transmission points based on the first control data; receiving second control data on a second control channel from a second one of the plurality of transmission points; and receiving and processing second data from the second one of the plurality of transmission points based on the second control data, wherein the first data and the second data are part of a single data Transport Block (TB).

Certain aspects of the present disclosure and their embodiments may provide solutions to the aforementioned or other challenges. Back to back PDSCH transmissions from different TRPs for a same TB are scheduled by separate PDCCHs, one for each PDSCH. Either multiple HARQ A/Ns, one per PDSCH or a single HARQ A/N can be sent by the UE.

There are, proposed herein, various embodiments which address one or more of the issues disclosed herein.

Certain embodiments may provide one or more of the following technical advantage(s). These include link adaptation according to the channel condition of each TRP and thus better utilization of each TRP link for improved data reliability and system capacity.

In some embodiments, a method for reliable data transmission in a wireless network comprising a plurality of transmission points includes providing first control data on a first control channel from a first one of the plurality of transmission points to a wireless device, the first control data providing scheduling information for receiving first data from the first one of the plurality of transmission points; and providing second control data on a second control channel from a second one of the plurality of transmission points to the wireless device, the second control data providing scheduling information for receiving second data form the second one of the plurality of transmission points, wherein the first data and the second data are part of a single data transport block.

In some embodiments, the method also includes providing the first data to the wireless device based on the scheduling information in the first control data. In some embodiments, the method also includes providing the second data to the wireless device based on the scheduling information in the second control data. In some embodiments, the first control data and the first data are provided in a single timeslot. In some embodiments, the second control data and the second data are provided in a single timeslot. In some embodiments, the first data is provided over multiple timeslots based on the first control data. In some embodiments, the second data is provided over multiple timeslots based on the second control data.

In some embodiments, a method for reliable data transmission in a wireless network comprising a plurality of transmission points, TRPs, and a user equipment, UE, includes scheduling, from the network to the UE, multiple PDSCHs with multiple PDCCHs for a same data transport block, TB, over the plurality of TRPs and multiple consecutive time slots.

In some embodiments, each of the PDCCHs schedules only one of the PDSCHs. In some embodiments, each of the PDCCHs may schedule more than one PDSCHs when slot aggregation is configured by higher layer. In some embodiments, each of the PDSCHs and associated PDCCH is transmitted from one of the TRPs and in one time slot. In some embodiments, only one PDSCH is transmitted in each slot.

In some embodiments, the TRP for a PDSCH is indicated by a Transmission Configuration Indicator (TCI) field of a Downlink Control Information, DCI, format carried in the corresponding PDCCH. In some embodiments, each of the PDSCHs may be configured with a different Modulation and Coding Scheme (MCS) and/or number of spatial layers, and/or resource allocation. In some embodiments, the MCS, the number of spatial layers, and the resource allocation would result in a same TB size for all the PDSCHs.

In some embodiments, all the PDSCHs are associated with a same HARQ process, which is signaled in the corresponding PDCCHs. In some embodiments, all the PDCCHs contains a same new data indication, NDI, value. In some embodiments, the UE sends a separate HARQ ACK/NACK feedback for each of the PDSCHs. In some embodiments, the UE sends a single HARQ ACK/NACK for all the PDSCHs. In some embodiments, all the PDCCHs may indicate a same value for PUCCH resource indicator, PRI, and a same value for PDSCH to HARQ timing indicator for HARQ ACK/NACK feedback.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a typical data scheduling in New Radio (NR) on a per slot basis, according to some embodiments of the present disclosure;

FIG. 2 illustrates a basic NR physical time-frequency resource grid, according to some embodiments of the present disclosure;

FIG. 3 shows an example where a Downlink Control Information (DCI) received by the wireless device in Physical Downlink Control Channel (PDCCH) from Transmission Reception Point (TRP) 1 schedules two Physical Downlink Shared Channels (PDSCHs), according to some embodiments of the present disclosure;

FIG. 4 illustrates two PDSCHs carrying the same transport block (TB) but with the same or different redundancy versions, according to some embodiments of the present disclosure;

FIG. 5 illustrates four Physical Data Channels (PDCHs) for a same Transport Block (TB) are transmitted over four TRPs and four consecutive slots, according to some embodiments of the present disclosure;

FIG. 6 illustrates one example of a cellular communications network, according to some embodiments of the present disclosure;

FIG. 7 illustrates a wireless communication system represented as a Fifth Generation (5G) network architecture composed of core Network Functions (NFs), according to some embodiments of the present disclosure;

FIG. 8 illustrates a 5G network architecture using service-based interfaces between the NFs in the control plane, instead of the point-to-point reference points/interfaces used in the 5G network architecture of FIG. 7, according to some embodiments of the present disclosure;

FIG. 9 illustrates each of the multiple PDSCHs is scheduled by a separate PDCCH, according to some embodiments of the present disclosure;

FIG. 10 illustrates the PDSCH-to-HARQ_feedback timing indicator field in each of the multiple PDCCHs scheduling the PDSCHs may point to the same slot, according to some embodiments of the present disclosure;

FIG. 11 shows an example where two PDCCHs are sent from TRPs #0 and #1, according to some embodiments of the present disclosure;

FIG. 12 is a flow chart illustrating a method for operating a wireless network including a number of transmission points, according to some embodiments of the present disclosure;

FIG. 13 is a flow chart illustrating a method for operating a wireless device in a wireless network including multiple transmission points, according to some embodiments of the present disclosure;

FIG. 14 is a schematic block diagram of a radio access node according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node according to some other embodiments of the present disclosure;

FIG. 17 is a schematic block diagram of a wireless communication device according to some embodiments of the present disclosure;

FIG. 18 is a schematic block diagram of the wireless communication device according to some other embodiments of the present disclosure;

FIG. 19 illustrates a communication system which includes a telecommunication network, such as a Third Generation Partnership Project (3GPP)-type cellular network, which comprises an access network, such as a Radio Access Network (RAN), and a core network, according to some embodiments of the present disclosure;

FIG. 20 illustrates a communication system, a host computer comprises hardware including a communication interface configured to set up and maintain a wired or wireless connection with an interface of a different communication device of the communication system, according to some embodiments of the present disclosure;

FIGS. 21-24 are flowcharts illustrating methods implemented in a communication system, according to some embodiments of the present disclosure.

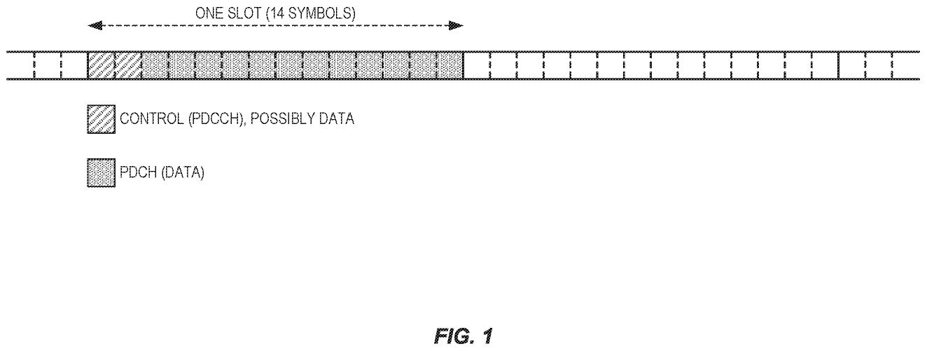

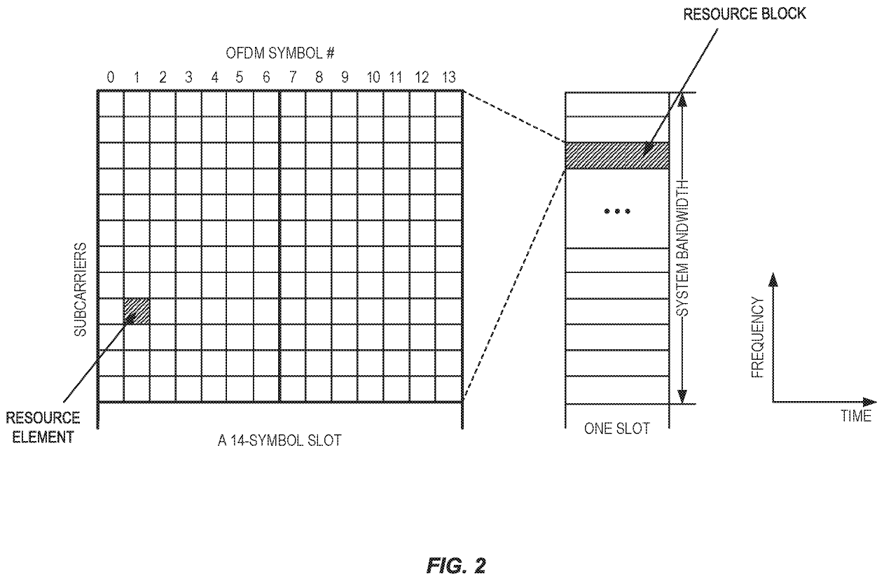

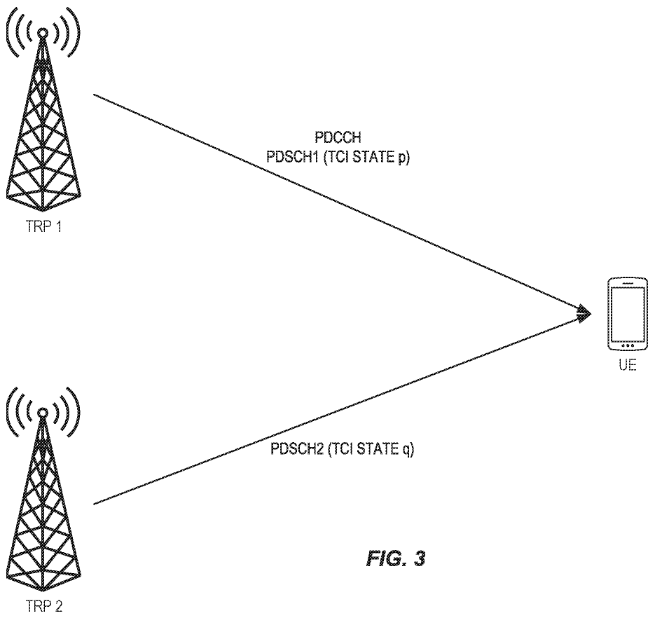

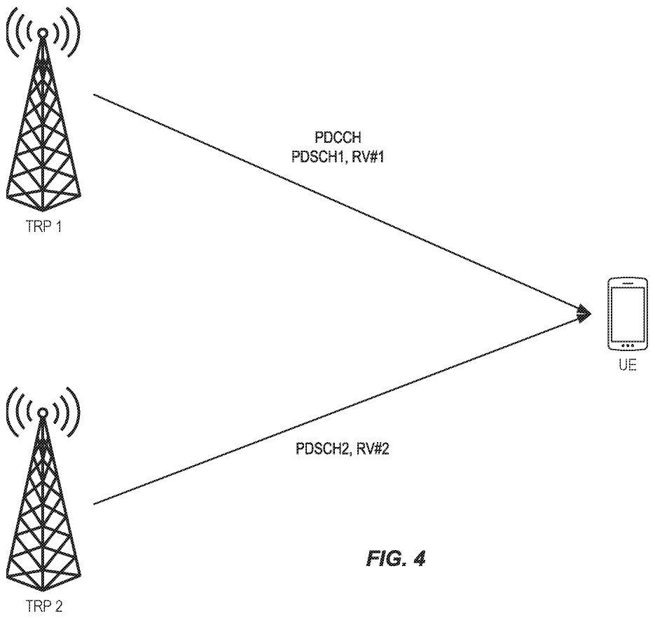

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

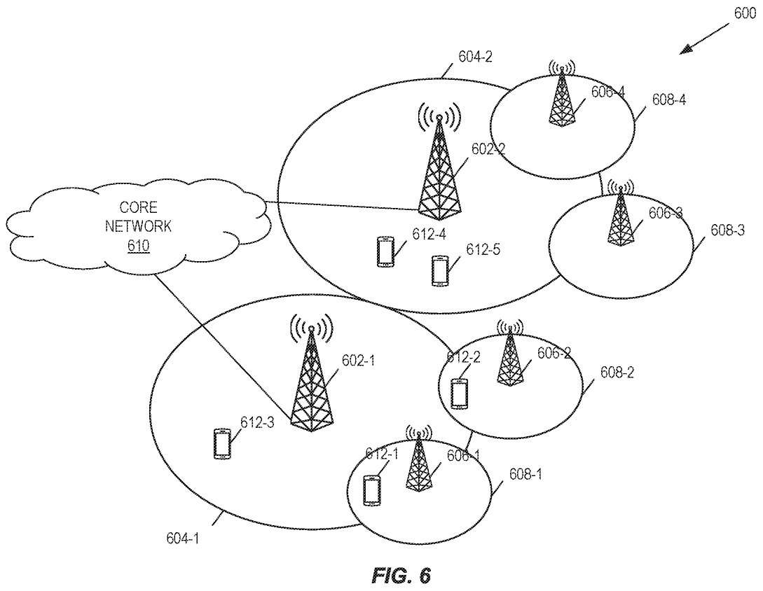

FIG. 6 illustrates one example of a cellular communications network 600 according to some embodiments of the present disclosure. In the embodiments described herein, the cellular communications network 600 is a 5G NR network. In this example, the cellular communications network 600 includes base stations 602-1 and 602-2, which in LTE are referred to as eNBs and in 5G NR are referred to as gNBs, controlling corresponding macro cells 604-1 and 604-2. The base stations 602-1 and 602-2 are generally referred to herein collectively as base stations 602 and individually as base station 602. Likewise, the macro cells 604-1 and 604-2 are generally referred to herein collectively as macro cells 604 and individually as macro cell 604. The cellular communications network 600 may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The base stations 602 (and optionally the low power nodes 606) are connected to a core network 610.

The base stations 602 and the low power nodes 606 provide service to wireless devices 612-1 through 612-5 in the corresponding cells 604 and 608. The wireless devices 612-1 through 612-5 are generally referred to herein collectively as wireless devices 612 and individually as wireless device 612. The wireless devices 612 are also sometimes referred to herein as UEs.

FIG. 7 illustrates a wireless communication system represented as a 5G network architecture composed of core Network Functions (NFs), where interaction between any two NFs is represented by a point-to-point reference point/interface. FIG. 7 can be viewed as one particular implementation of the system 600 of FIG. 6.

Seen from the access side the 5G network architecture shown in FIG. 7 comprises a plurality of User Equipment (UEs) connected to either a Radio Access Network (RAN) or an Access Network (AN) as well as an Access and Mobility Management Function (AMF). Typically, the R(AN) comprises base stations, e.g., such as evolved Node Bs (eNBs) or 5G base stations (gNBs) or similar. Seen from the core network side, the 5G core NFs shown in FIG. 7 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and User Plane Function (UPF) are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 7, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 7. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

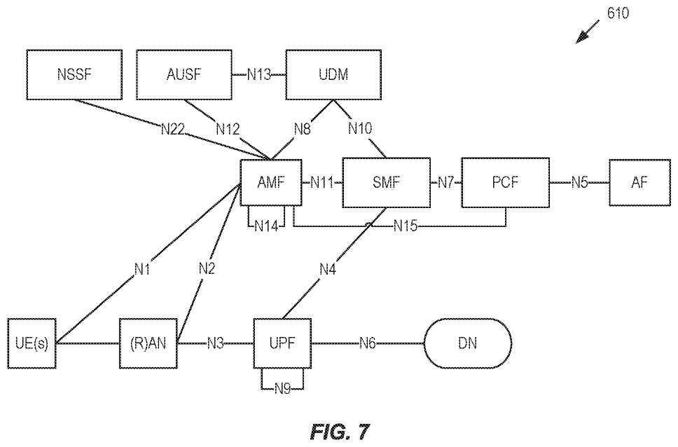

FIG. 8 illustrates a 5G network architecture using service-based interfaces between the NFs in the control plane, instead of the point-to-point reference points/interfaces used in the 5G network architecture of FIG. 7. However, the NFs described above with reference to FIG. 7 correspond to the NFs shown in FIG. 8. The service(s) etc. that a NF provides to other authorized NFs can be exposed to the authorized NFs through the service-based interface. In FIG. 8 the service based interfaces are indicated by the letter “N” followed by the name of the NF, e.g., Namf for the service based interface of the AMF and Nsmf for the service based interface of the SMF etc. The Network Exposure Function (NEF) and the Network Repository Function (NRF) in FIG. 8 are not shown in FIG. 7 discussed above. However, it should be clarified that all NFs depicted in FIG. 7 can interact with the NEF and the NRF of FIG. 8 as necessary, though not explicitly indicated in FIG. 7.

Some properties of the NFs shown in FIGS. 7 and 8 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

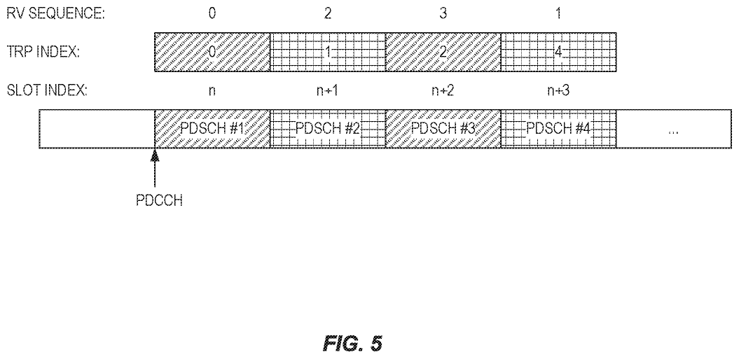

In 3GPP RAN1 #96bis, it was agreed that a slot based TDM scheme (scheme 4), similar to slot aggregation in NR R15, will be supported in NR Rel-16, in which PDSCHs in consecutive slots may be transmitted from different TRPs. The transmissions from different TRPs correspond to different TCI states (i.e., a different TCI state is associated with the PDSCH transmitted from each different TRP). An example is shown in FIG. 5, where four PDCHs for a same TB are transmitted over four TRPs and four consecutive slots. Each PDSCH is associated with a different RV. The RV and TRP associated with each slot can be either preconfigured or dynamically signaled.

There currently exist certain challenges. With the 3GPP agreed TDM scheme for PDSCH transmission, only a common MCS and rank can be used for the multiple PDSCHs. For single TRP transmission, a common MCS and rank is fine as the channel will not change much over a few consecutive slots. For multi-TRP, however, the channels between different TRPs and a UE can be very different. It would be difficult to adapt the channel conditions using a single common MCS and rank in different TRPs; thus, this method is not efficient for fully utilizing the channel capacities for reliable data transmission. As such, improved systems and methods are needed.

Systems and methods for reliable data transmission over multiple TRPs are provided. In some embodiments, a method performed by a wireless device for reliable data transmission in a wireless network including multiple transmission points includes: receiving first control data on a first control channel from a first one of the plurality of transmission points; receiving and processing first data from the first one of the plurality of transmission points based on the first control data; receiving second control data on a second control channel from a second one of the plurality of transmission points; and receiving and processing second data from the second one of the plurality of transmission points based on the second control data, wherein the first data and the second data are part of a single data TB. In this way, link adaptation can be performed according to the channel condition of each TRP, and thus better utilization of each TRP link for improved data reliability and system capacity are provided.

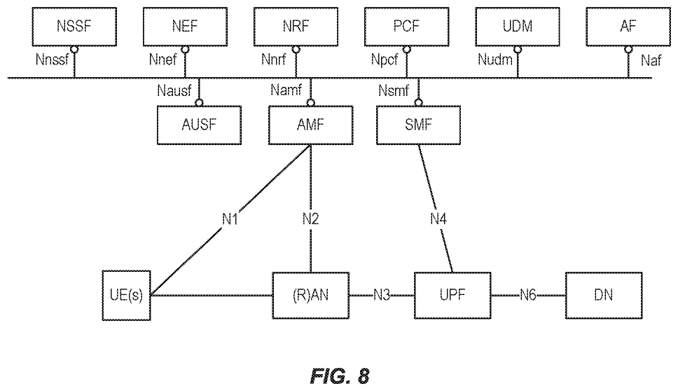

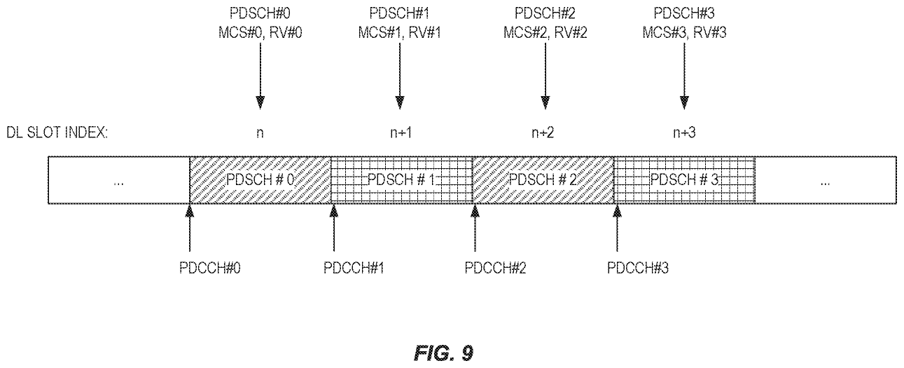

Back to back PDSCH transmissions over multiple TRPs with separate PDCCHs. Instead of using a single PDCCH to trigger multiple PDSCH transmissions over consecutive slots and multiple TRPs as it is done in the 3GPP agreed slot based TDM scheme, in this embodiment, each of the multiple PDSCHs is scheduled by a separate PDCCH as shown in FIG. 9, where the PDSCHs belong to the same HARQ process and are for the same TB. This allows different MCSs and/or ranks to be scheduled from different TRPs to adapt the individual channel conditions. At the UE side, it recognizes that the multiple PDSCHs are for the same TB as they share the same HARQ process number and the same New Data Indication (NDI) bit value, both are indicated in the corresponding PDCCHs. Therefore, when the second and subsequent PDSCHs are received, the UE combines the soft bits of the current received PDSCH with the ones of the previously received PDSCHs before decoding.

In one embodiment, a separate HARQ A/N is reported for each PDSCH after soft combining with the previously received PDSCH(s) for the same TB. In this case, the gNB would receive multiple HARQ A/Ns; each corresponds to one of the multiple PDSCHs. The gNB knows that the TB is successfully received at the UE if one of the multiple A/Ns is an ACK. The advantage of this approach is that the PUCCH resource allocation and HARQ A/N multiplexing procedure are unchanged. The drawback is that some of the HARQ A/Ns may be wasted, and so are the associated PUCCH resources. However, even though multiple A/Ns are transmitted, where only the latest A/N can be considered useful, it could still be beneficial from a diversity perspective to transmit multiple A/Ns indicating the same information in order to improve the reliability, i.e., reduce the possible of misdetection of the A/N by the gNB. Another form of transmission of multiple A/N may be useful is for the gNB to observe how many repetitions are needed for the UE to decode the TB. For instance, if four repetitions are used and the UE transmits the following sequence of A/N: [NACK, NACK, ACK, ACK], the gNB determines that three repetitions are actually needed for the UE to decode the TB. Based on observing such statistics across multiple transmission occasions, the gNB can determine the appropriate number of repetitions to schedule a TB to the UE .

In one variant of this embodiment, if the A/N corresponding to the PDSCH in slot n is reported in the same slot such as by a short PUCCH at the end of the slot, then the outcome of the A/N report can be used by the network to decide if further repetitions of the same TB from other TRPs are needed. If the UE reports an ACK in slot n corresponding to a PDSCH received in the same slot, then the network can decide that additional repetitions are not needed and PDCCHs #1, #2, and #3 (referring to FIG. 9) are not transmitted by the network. On the other hand, if the UE reports a NACK in slot n corresponding to the PDSCH in the same slot, then the network can decide that additional repetitions are needed.

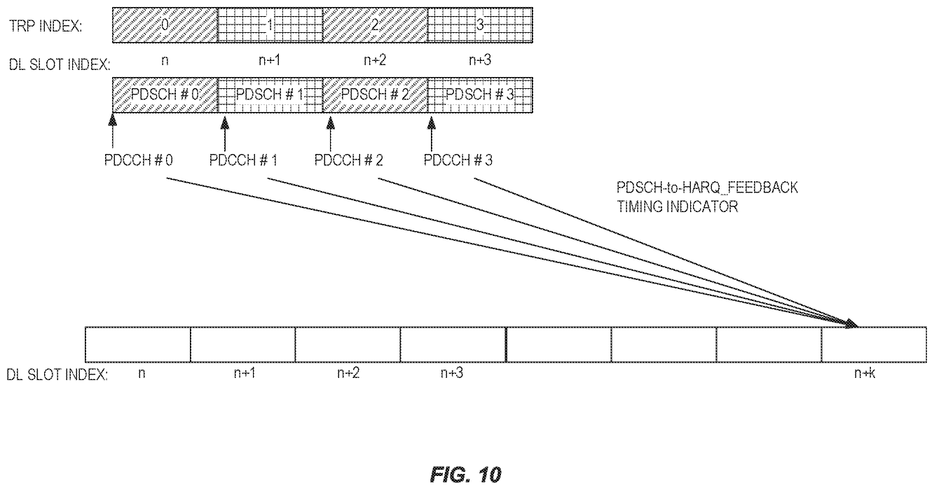

In some scenarios, since the multiple PDSCHs are for the same TB, the gNB may not expect to receive a HARQ A/N before completing the last PDSCH, i.e., only a single A/N needs to be received by the gNB to determine whether the TB is received correctly by the UE, not necessarily for each individual PDSCH transmission. Thus, in another embodiment, the UE may drop A/N for a PDSCH if another PDSCH of the same HARQ process is received before the A/N transmission. The PDSCH-to-HARQ_feedback timing indicator field in each of the multiple PDCCHs scheduling the PDSCHs may point to a same slot as shown in FIG. 10. Also, the same PUCCH resource may be indicated by the PUCCH Resource Indicator (PRI) field in the DCIs. Thus, the UE sends only a single HARQ A/N on the PUCCH source in slot n+k for the multiple PDSCHs.

One way to implement the above procedure in the specification is to define a dropping rule such that if multiple A/Ns for the same HARQ process ID are scheduled to be transmitted in the same or colliding PUCCH resources, i.e., overlapping in time, only one of the A/Ns are reported and the other A/N transmissions are dropped (e.g., an ACK is reported if one PDSCH is decoded successfully and a NACK is reported if none of the PDSCHs are decoded successfully). The transmitted A/N may correspond to the latest received PDSCH for the HARQ process ID.

TBS determination with multiple PDSCH of the same TB: When the UE receives multiple PDCCH scheduling PDSCHs comprising the same TB, according to the previously described embodiments, different RVs of the same TB are transmitted and thus the TB size (TBS) must necessarily be the same for the different PDSCHs. The TBS is indirectly indicated by the MCS field of the DCI, where the MCS field directly indicates a modulation order and a target code rate. The TBS is calculated according to a TBS determination procedure which uses the modulation order, target code rate, number of layers and PDSCH resource allocation as input. The aim of this procedure is to calculate a TBS which results in an effective code rate this is close to the target code rate.

In case of PDSCH retransmissions under the existing 3GPP standard, the “reserved” MCS fields are typically used where only a modulation order and not a target code rate is indicated. In this case, the TBS is determined from the MCS field of a previously transmitted DCI for the same HARQ process.

Since the TBS must be the same for all PDSCH repetitions, in an embodiment, only the first PDCCH (where the NDI bit is toggled) indicates an MCS codepoint which comprises a target code rate, while the remaining PDCCHs scheduling the repeated PDSCH indicate a MCS codepoint which does not comprise a target code rate, such that the TBS is determined from the first PDCCH.

However, there may be an issue if the UE misses the first PDCCH, since the TBS would then be unknown. For the case of regular retransmissions under the existing 3GPP standard, the gNB would only send a PDCCH with a reserved MCS field if the UE explicitly indicated a NACK of the original transmission PDSCH. That is, the gNB would know if the UE missed the PDCCH and in that case for the retransmission use an MCS which indicates a target code rate so that the TBS can be determined. However, in the back-to-back PDSCH repetition case, there may not be a HARQ-ACK transmission before the second PDSCH is to be transmitted; and furthermore, the second PDSCH may benefit from being transmitted with a different modulation and or coding scheme to adapt to the channel conditions of the second TRP.

To address this, in an embodiment, the subsequent PDCCH transmissions scheduling back-to-back PDSCH repetitions indicate an MCS codepoint comprising a target code rate, but where the MCS, number of layers and resource allocation is selected in such a manner that the determined TBS according to the TBS determination procedure results in the same TBS as for the first PDSCH transmission. For instance, the second PDSCH may be transmitted using a larger resource allocation but with a lower code rate compared to the first PDSCH. In one embodiment, the UE considers it an error case if a different TBS size is indicated for a TB of the same HARQ process compared to what a previous PDCCH indicated and drops reception of the PDSCH transmission(s). In another embodiment, the UE clears out its soft buffer of the TB if a different TBS is indicated compared the previously received PDCCH of the same HARQ process, even if the NDI bit is not toggled.

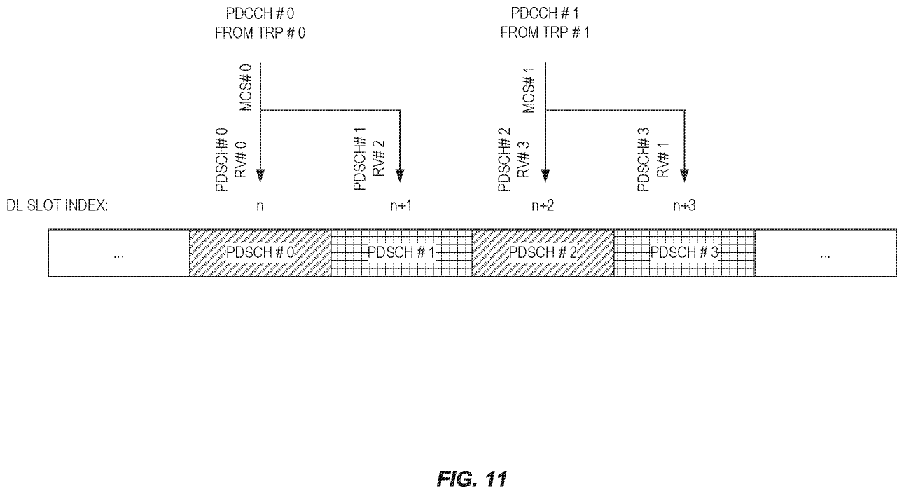

Back to back PDSCH transmissions over multiple TRPs with separate PDCCHs and slot aggregation: In this embodiment, back to back PDSCHs are transmitted from multiple TRPs with a combination of separate PDCCHs and slot aggregation. The PDSCHs transmitted from the multiple TRPs belong to the same HARQ process and are for the same TB. FIG. 11 shows an example where two PDCCHs are sent from TRPs #0 and #1. PDCCH #0 indicates PDSCHs #0 and #1 (which corresponds to a pdsch-AggregationFactor of 2) with MCS #0. Similarly, PDCCH #1 indicates PDSCHs #2 and #3 (corresponding to pdsch-AggregationFactor of 2) with MCS #1. The appropriate RVs are indicated via the DCIs in PDCCHs that schedule the PDSCHs using Table (1) discussed above. As all four PDSCHs in this example belong to the same HARQ process, then both PDCCHs #0 and #1 indicate the same HARQ process ID. This embodiment essentially achieves a PDSCH aggregation factor of four but uses two PDCCHs instead of one (as is the case in NR Rel-16) which helps in indicating different MCSs associated with different TRPs.

In some embodiments, separate A/Ns are reported for PDSCHs scheduled by the separate PDCCHs. That is, one A/N is reported corresponding PDSCHs #0 and #1 scheduled by PDCCH #0 from TRP #0. If the A/N corresponding to PDSCHs #0 and #1 is transmitted in slot n+1 and if an ACK is reported, then the network may skip transmitting PDCCH #1 (and hence, PDSCHs #2 and #3) since the TB of interest is already decoded successfully and there is no need for additional repetitions. On the other hand, if the A/N corresponding to PDSCHs #0 and #1 is transmitted in slot n+1 and if a NACK is reported, then the network will transmit PDCCH #1 (and hence, PDSCHs #2 and #3) since the TB of interest is not yet decoded successfully and additional repetitions may be beneficial.

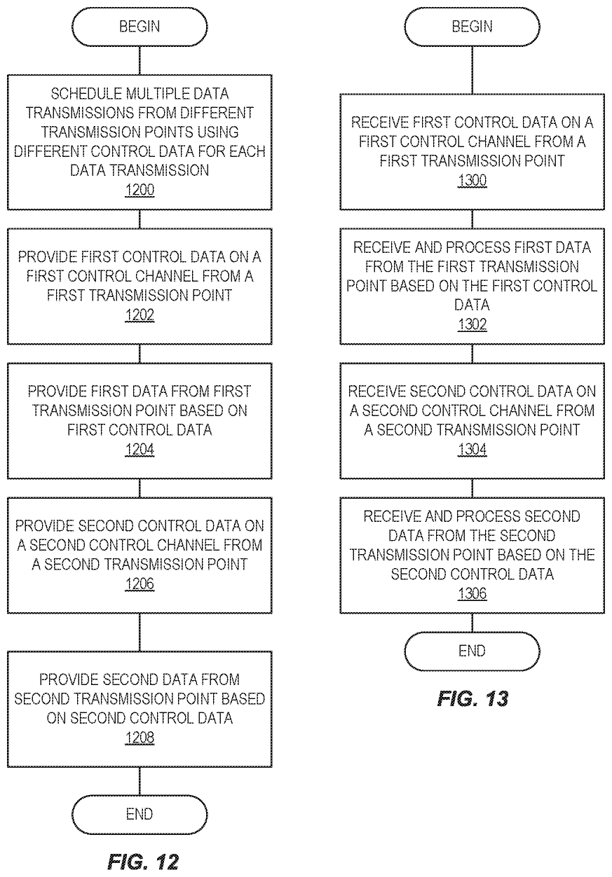

FIG. 12 is a flow chart illustrating a method for operating a wireless network including a number of transmission points according to one embodiment of the present disclosure. First, multiple data transmission are scheduled from different transmission points using different control data for each data transmission (step 1200). This is accomplished according to the principles discussed above. First control data is then provided on a first control channel from a first transmission point to a wireless device (step 1202). Notably, the first control data includes scheduling information about the transmission of first data from the first transmission point such that the first data can be received and processed by the wireless device. The first data is then provided to the wireless device from the first transmission point based on the first control data (step 1204). Second control data is then provided on a second control channel from a second transmission point to the wireless device (step 1206). Notably, the second control data includes scheduling information about the transmission of second data form the second transmission point such that the second data can be received and processed by the wireless device. The second data is then provided to the wireless device from the second transmission point based on the second control data (step 1208). The first data and the second data are for the same data transmission block. As discussed above, the first data and the second data are for the same TB but with different redundancy versions to ensure the reliable reception of the data at the wireless device. By providing first control data for the first data and second control data for the second data, the first data and the second data may be transmitted using different transmission characteristics (e.g., modulation and coding scheme, etc.) such that the reliability of data transmission over the link between the first transmission point and the wireless device and the second transmission point and the wireless device is improved.

FIG. 13 is a flow chart illustrating a method for operating a wireless device in a wireless network including multiple transmission points according to one embodiment of the present disclosure. First, first control data is received on a first control channel from a first transmission point (step 1300). First data is then received and processed based on the first control data (step 1302). Next, second control data is received on a second control channel from a second transmission point (step 1304). Second data is then received and processed based on the second control data (step 1306). By receiving and processing the first data and the second data based on the first control data and the second control data, respectively, the first data and the second data may be received using different characteristics (e.g., modulation and coding scheme, etc.) such that the reliability of data transmission over the link between the first transmission point and the wireless device and the second transmission point and the wireless device is improved.

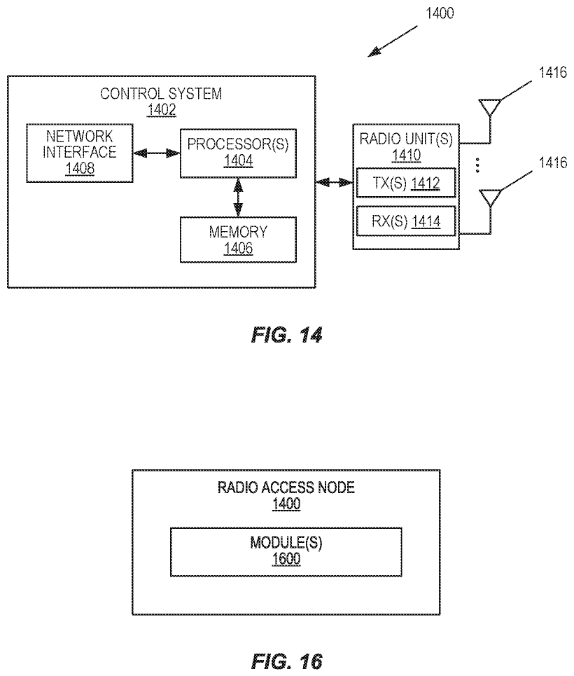

FIG. 14 is a schematic block diagram of a radio access node 1400 according to some embodiments of the present disclosure. The radio access node 1400 may be, for example, a base station 602 or 606. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 includes one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

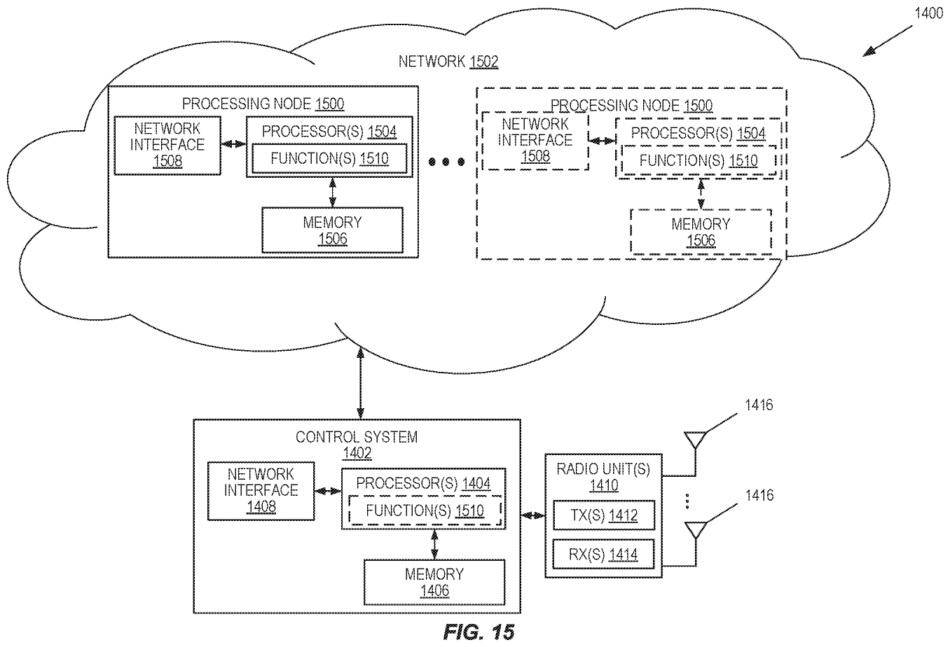

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 includes the control system 1402 that includes the one or more processors 1404 (e.g., CPUs, ASICs, FPGAs, and/or the like), the memory 1406, and the network interface 1408 and the one or more radio units 1410 that each includes the one or more transmitters 1412 and the one or more receivers 1414 coupled to the one or more antennas 1416, as described above. The control system 1402 is connected to the radio unit(s) 1410 via, for example, an optical cable or the like. The control system 1402 is connected to one or more processing nodes 1500 coupled to or included as part of a network(s) 1502 via the network interface 1408. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the control system 1402 and the one or more processing nodes 1500 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

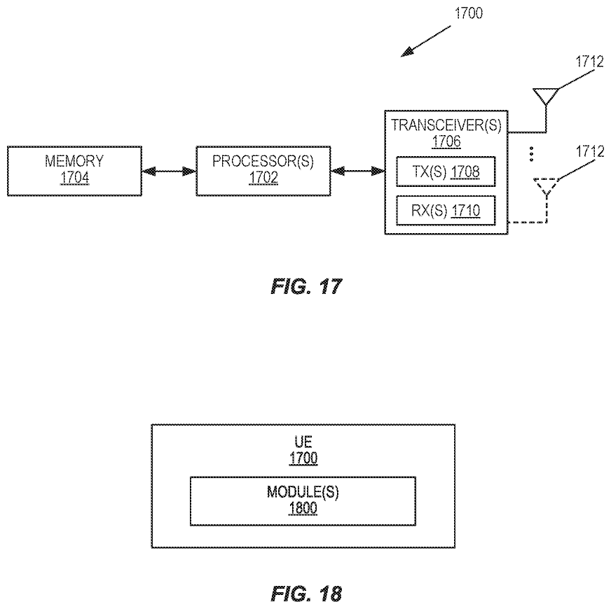

FIG. 17 is a schematic block diagram of a UE 1700 according to some embodiments of the present disclosure. As illustrated, the UE 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the UE 1700 described above may be fully or partially implemented in software that is, e.g., stored in the memory 1704 and executed by the processor(s) 1702. Note that the UE 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the UE 1700 and/or allowing output of information from the UE 1700), a power supply (e.g., a battery and associated power circuitry), etc.

In some embodiments, a computer program including instructions which, when executed by at least one processor, causes the at least one processor to carry out the functionality of the UE 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the UE 1700 according to some other embodiments of the present disclosure. The UE 1700 includes one or more modules 1800, each of which is implemented in software. The module(s) 1800 provide the functionality of the UE 1700 described herein.

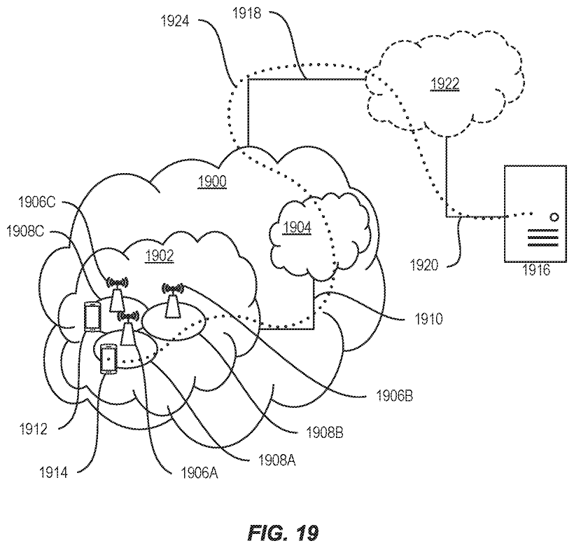

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as NBs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

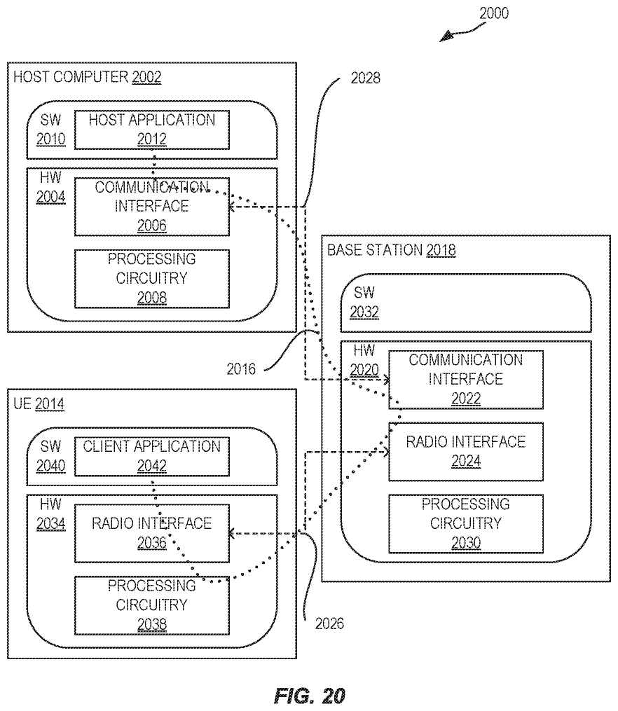

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment. More precisely, the teachings of these embodiments may improve the link adaptation according to the channel condition of each TRP and thereby provide benefits such as improved data reliability and system capacity.

A measurement procedure may be provided for the purpose of monitoring data rate, latency, and other factors on which the one or more embodiments improve.

There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002's measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

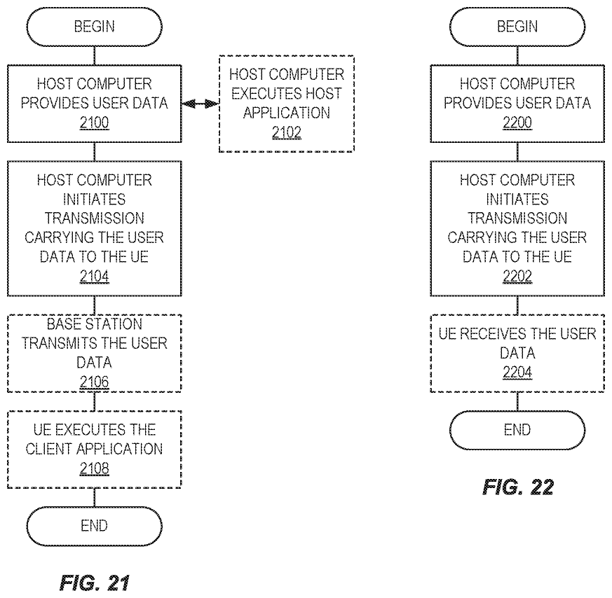

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE.

In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE.

The transmission may pass via the base station, in accordance with the teachings of the embodiments described throughout this disclosure. In step 2204 (which may be optional), the UE receives the user data carried in the transmission.

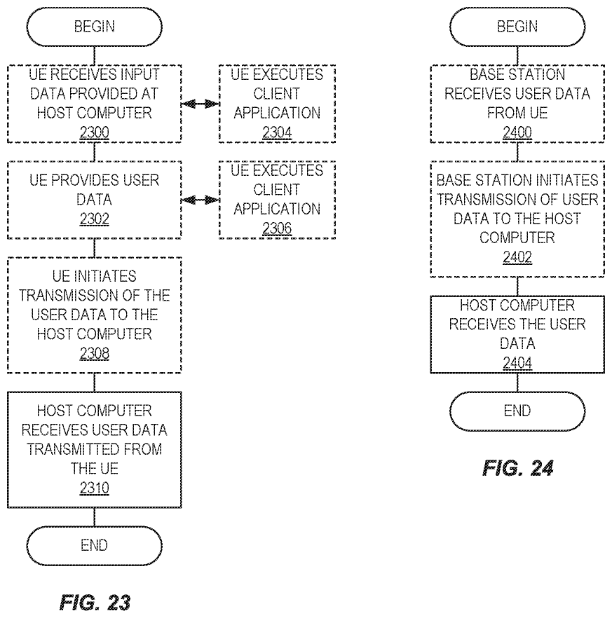

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: A method performed by a wireless device for reliable data transmission in a wireless network comprising a plurality of transmission points, the method comprising one or more of the following: receiving first control data on a first control channel from a first one of the plurality of transmission points; receiving and processing first data from the first one of the plurality of transmission points based on the first control data; receiving second control data on a second control channel from a second one of the plurality of transmission points; and receiving and processing second data from the second one of the plurality of transmission points based on the second control data, wherein the first data and the second data are part of a single data transport block.

Embodiment 2: The method of the previous embodiment wherein the first data and the second data are the same data with a different redundancy scheme applied thereto.

Embodiment 3: The method of any of the previous embodiments wherein the first control data and the first data are received in a single timeslot.

Embodiment 4: The method of the previous embodiment wherein the second control data and the second data are received in a single timeslot.

Embodiment 5: The method of the first embodiment in Group A wherein the first data is received over multiple timeslots based on the first control data.

Embodiment 6: The method of the previous embodiment wherein the second data is received over multiple timeslots based on the second control data.

Embodiment 7: The method of any of the previous embodiments, further comprising: providing user data; and forwarding the user data to a host computer via the transmission to the base station.

### Group B Embodiments

Embodiment 8: A method for reliable data transmission in a wireless network comprising a plurality of transmission points, the method comprising one or more of the following: providing first control data on a first control channel from a first one of the plurality of transmission points to a wireless device, the first control data providing scheduling information for receiving first data from the first one of the plurality of transmission points; and providing second control data on a second control channel from a second one of the plurality of transmission points to the wireless device, the second control data providing scheduling information for receiving second data form the second one of the plurality of transmission points, wherein the first data and the second data are part of a single data transport block.

Embodiment 9: The method of the previous embodiment further comprising providing the first data to the wireless device based on the scheduling information in the first control data.

Embodiment 10: The method of the previous embodiment further comprising providing the second data to the wireless device based on the scheduling information in the second control data.

Embodiment 11: The method of the first embodiment in Group B wherein the first control data and the first data are provided in a single timeslot.

Embodiment 12: The method of the previous embodiment wherein the second control data and the second data are provided in a single timeslot.

Embodiment 13: The method of the first embodiment in Group B wherein the first data is provided over multiple timeslots based on the first control data.

Embodiment 14: The method of the previous embodiment wherein the second data is provided over multiple timeslots based on the second control data.

Embodiment 15: The method of any of the previous embodiments, further comprising: obtaining user data; and forwarding the user data to a host computer or a wireless device.

### Group C Embodiments

Embodiment 16: A wireless device for reliable data transmission in a wireless network comprising a plurality of transmission points, the wireless device comprising:

processing circuitry configured to perform any of the steps of any of the Group A embodiments; and power supply circuitry configured to supply power to the wireless device.

Embodiment 17: A base station for reliable data transmission in a wireless network comprising a plurality of transmission points, the base station comprising:

processing circuitry configured to perform any of the steps of any of the Group B embodiments; and power supply circuitry configured to supply power to the base station.

Embodiment 18: A User Equipment, UE, for reliable data transmission in a wireless network comprising a plurality of transmission points, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 19: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 20: The communication system of the previous embodiment further including the base station.

Embodiment 21: The communication system of the previous 2 embodiments, further including the UE, wherein the UE is configured to communicate with the base station.

Embodiment 22: The communication system of the previous 3 embodiments, wherein: the processing circuitry of the host computer is configured to execute a host application, thereby providing the user data; and the UE comprises processing circuitry configured to execute a client application associated with the host application.

Embodiment 23: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 24: The method of the previous embodiment, further comprising, at the base station, transmitting the user data.

Embodiment 25: The method of the previous 2 embodiments, wherein the user data is provided at the host computer by executing a host application, the method further comprising, at the UE, executing a client application associated with the host application.

Embodiment 26: A User Equipment, UE, configured to communicate with a base station, the UE comprising a radio interface and processing circuitry configured to perform the method of the previous 3 embodiments.

Embodiment 27: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 28: The communication system of the previous embodiment, wherein the cellular network further includes a base station configured to communicate with the UE.

Embodiment 29: The communication system of the previous 2 embodiments, wherein: the processing circuitry of the host computer is configured to execute a host application, thereby providing the user data; and the UE's processing circuitry is configured to execute a client application associated with the host application.

Embodiment 30: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 31: The method of the previous embodiment, further comprising at the UE, receiving the user data from the base station.

Embodiment 32: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 33: The communication system of the previous embodiment, further including the UE.

Embodiment 34: The communication system of the previous 2 embodiments, further including the base station, wherein the base station comprises a radio interface configured to communicate with the UE and a communication interface configured to forward to the host computer the user data carried by a transmission from the UE to the base station.

Embodiment 35: The communication system of the previous 3 embodiments, wherein: the processing circuitry of the host computer is configured to execute a host application; and the UE's processing circuitry is configured to execute a client application associated with the host application, thereby providing the user data.

Embodiment 36: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 37: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 38: The method of the previous embodiment, further comprising, at the UE, providing the user data to the base station.

Embodiment 39: The method of the previous 2 embodiments, further comprising: at the UE, executing a client application, thereby providing the user data to be transmitted; and at the host computer, executing a host application associated with the client application.

Embodiment 40: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data

Embodiment 41: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 42: The communication system of the previous embodiment further including the base station.

Embodiment 43: The communication system of the previous 2 embodiments, further including the UE, wherein the UE is configured to communicate with the base station.

Embodiment 44: The communication system of the previous 3 embodiments, wherein: the processing circuitry of the host computer is configured to execute a host application; and the UE is configured to execute a client application associated with the host application, thereby providing the user data to be received by the host computer.

Embodiment 45: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 46: The method of the previous embodiment, further comprising at the base station, receiving the user data from the UE.

Embodiment 47: The method of the previous 2 embodiments, further comprising at the base station, initiating a transmission of the received user data to the host computer.

### Group D Embodiments

Embodiment 48: A method for reliable data transmission in a wireless network comprising a plurality of transmission points, TRPs, and a user equipment, UE, the method comprising: scheduling, from the network to the UE, multiple PDSCHs with multiple PDCCHs for a same data transport block, TB, over the plurality of TRPs and multiple consecutive time slots.

Embodiment 49: The method of the first embodiment in Group D, wherein each of the PDCCHs schedules only one of the PDSCHs.

Embodiment 50: The method of the first embodiment in Group D, wherein each of the PDCCHs may schedule more than one PDSCHs when slot aggregation is configured by higher layer.

Embodiment 51: The method of the first embodiment in Group D, wherein each of the PDSCHs and associated PDCCH is transmitted from one of the TRPs and in one time slot.

Embodiment 52: The method of the first embodiment and the fourth embodiment in Group D, wherein only one PDSCH is transmitted in each slot.

Embodiment 53: The method of the first embodiment and the fourth embodiment in Group D, wherein the TRP for a PDSCH is indicated by a Transmission Configuration Indicator, TCI, field of a Downlink Control Information, DCI, format carried in the corresponding PDCCH.

Embodiment 54: The method of the first embodiment in Group D, wherein each of the PDSCHs may be configured with a different Modulation and Coding Scheme, MCS, and/or number of spatial layers, and/or resource allocation.

Embodiment 55: The method of the first embodiment and the seventh embodiment in Group D, wherein the MCS, the number of spatial layers, and the resource allocation would result in a same TB size for all the PDSCHs.

Embodiment 56: The method of the first embodiment in Group D, wherein all the PDSCHs are associated with a same HARQ process, which is signaled in the corresponding PDCCHs.

Embodiment 57: The method of the first embodiment in Group D, wherein all the PDCCHs contains a same new data indication, NDI, value.

Embodiment 58: The method of the first embodiment in Group D, wherein the UE sends a separate HARQ ACK/NACK feedback for each of the PDSCHs.

Embodiment 59: The method of the first embodiment in Group D, wherein the UE sends a single HARQ ACK/NACK for all the PDSCHs.

Embodiment 60: The method of the first embodiment and the twelfth embodiment in Group D, wherein all the PDCCHs may indicate a same value for PUCCH resource indicator, PRI, and a same value for PDSCH to HARQ timing indicator for HARQ ACK/NACK feedback.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
A/N Acknowledgement/Negative Acknowledgement
ACK Acknowledgement
AF Application Function
AMF Access and Mobility Function
AN Access Network
AP Access Point
ASIC Application Specific Integrated Circuit
AUSF Authentication Server Function
CA Carrier Aggregation
CP-OFDM Cyclic Prefix Orthogonal Frequency Division Multiplexing
CPU Central Processing Unit
CQI Channel Quality Information
CSI Channel State Information
CSI-RS Channel State Information Reference Signal
DFT-S-OFDM Discrete Fourier Transform Spread Orthogonal Frequency Division Multiplexing
DL Downlink
DMRS Demodulation Reference Signal
DN Data Network
DSP Digital Signal Processor
eNB Enhanced or Evolved Node B
FPGA Field Programmable Gate Array
FR Frequency Range
gNB New Radio Base Station
HARQ Hybrid Automatic Repeat Request
HSS Home Subscriber Server
IP Internet Protocol
LTE Long Term Evolution
MCS Modulation and Coding Scheme
MME Mobility Management Entity
MTC Machine Type Communication
NACK Negative Acknowledgement
NDI New Data Indication
NEF Network Exposure Function
NF Network Function
NR New Radio
NRF Network Function Repository Function
NSSF Network Slice Selection Function
OTT Over-the-Top
PBCH Physical Broadcasting Channel
PCF Policy Control Function
PDCCH Physical Downlink Control Channel
PDCH Physical Data Channel
PDSCH Physical Downlink Shared Channel
P-GW Packet Data Network Gateway
PMI Precoding Matrix Indicator
PRI PUCCH Resource Indicator
PUCCH Physical Uplink Control Channel
PUCCH Physical Uplink Shared Channel
QCL Quasi Co-Located
QoS Quality of Service
RAM Random Access Memory
RAN Radio Access Network
RB Resource Block
RE Resource Element
RI Rank Indicator
ROM Read Only Memory
RRC Radio Resource Control
RRH Remote Radio Head
RTT Round Trip Time
RV Redundancy Version
SCEF Service Capability Exposure Function
SCS Subcarrier Spacing
SMF Session Management Function
SR Scheduling Request
TB Transport Block
TBS Transport Block Size
TCI Transmission Configuration Indicator
TDM Time Domain Multiplexing
TRP Transmission Reception Point
UCI Uplink Control Information
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a wireless device for reliable data transmission in a wireless network comprising a plurality of transmission points, each associated with one or more Transmission Configuration Indicator, TCI, state, the method comprising:
receiving first control data on a first control channel from a first one of the plurality of transmission points;
receiving and processing first data from the first one of the plurality of transmission points based on the first control data;
receiving second control data on a second control channel from a second one of the plurality of transmission points; and
receiving and processing second data from the second one of the plurality of transmission points based on the second control data, wherein the first data and the second data are associated to a same data Transport Block, TB.

2. The method of claim 1 wherein the first data and the second data are encoded data for the same data TB with a same or different redundancy version.

3. The method of claim 1 wherein the first control data and the second control data are received in different time slots.

4. The method of claim 1 wherein the first data and the second data are received in different time slots.

5. The method of claim 1 wherein the first data is received prior to the second data.

6. The method of claim 1 wherein the first control data and the first data are received in a same or different timeslot.

7. The method of claim 1 wherein the second control data and the second data are received in the same or different timeslot.

8. The method of claim 1 wherein the first data is received over multiple timeslots based on the first control data.

9. The method of claim 1 wherein the second data is received over multiple timeslots based on the second control data.

10. The method of claim 1 wherein one or more of the first control data and the second control data schedules only one data transmission occasion.

11. The method of claim 1 wherein one or more of the first control data and the second control data schedules more than one data transmission occasion when slot aggregation is configured by a higher layer.

12. The method of claim 1 wherein the transmission point for a data transmission is indicated by a Transmission Configuration Indicator, TCI, field of a Downlink Control Information, DCI, format carried in corresponding control data.

13. The method of claim 1 wherein the first and the second data are configured with different Modulation and Coding Schemes, MCS, and/or number of spatial layers, and/or resource allocations.

14. The method of claim 13 wherein the different MCS, the number of spatial layers, and the resource allocations would result in a same TB size for the first and the second data.

15. The method of claim 1 wherein the first and the second data are associated with a same Hybrid Automatic Repeat Request, HARQ, process, which is signaled in the corresponding control data.

16. The method of claim 1 wherein the first and the second control data contain a same New Data Indication, NDI, value.

17. The method of claim 1 wherein the receiving and processing the first or the second data comprises decoding the TB based on the first or the second data.

18-26. (canceled)

27. A method for reliable data transmission in a wireless network comprising a plurality of transmission points, each associated with one or more Transmission Configuration Indicator, TCI, state, the method comprising:
providing first control data on a first control channel from a first one of the plurality of transmission points to a wireless device, the first control data providing scheduling information for a first data transmission;
providing the first data transmission from the first one of the plurality of transmission points; and
providing second control data on a second control channel from a second one of the plurality of transmission points to the wireless device, the second control data providing scheduling information for a second data transmission providing the second data transmission from the second one of the plurality of transmission points, wherein the first data and the second data are associated to a same data Transport Block, TB.

28-50. (canceled)

51. A wireless device for reliable data transmission in a wireless network comprising a plurality of transmission points, each associated with one or more Transmission Configuration Indicator, TCI, state, the wireless device comprising:
one or more processors; and
memory storing instructions executable by the one or more processors, whereby the wireless device is operable to:
receive first control data on a first control channel from a first one of the plurality of transmission points;
receive and process first data from the first one of the plurality of transmission points based on the first control data;
receive second control data on a second control channel from a second one of the plurality of transmission points; and
receive and process second data from the second one of the plurality of transmission points based on the second control data, wherein the first data and the second data are associated to a single same data Transport Block, TB.

52. (canceled)

53. A network node for reliable data transmission in a wireless network comprising a plurality of transmission points, each associated with one or more Transmission Configuration Indicator, TCI, state, the network node comprising:
one or more processors; and
memory comprising instructions to cause the network node to:
provide first control data on a first control channel from a first one of the plurality of transmission points to a wireless device, the first control data providing scheduling information for a first data transmission;
provide the first data transmission from the first one of the plurality of transmission points; and
provide second control data on a second control channel from a second one of the plurality of transmission points to the wireless device, the second control data providing scheduling information for a second data transmission
provide the second data transmission from the second one of the plurality of transmission points, wherein the first data and the second data are associated to a same data Transport Block, TB.

54. (canceled)
